(19) United States
(12) Patent Application Publication
(10) Pub. No.: US 2012/0185381 A1
(43) Pub. Date: Jul. 19, 2012

(54) APPARATUS AND METHOD FOR GENERATING CONSUMPTION PATTERNS

(75) Inventor: Sung Min KIM, Gunpo-si (KR)

(73) Assignee: PANTECH CO., LTD., Seoul (KR)

(21) Appl. No.: 13/228,959

(22) Filed: Sep. 9, 2011

(30) Foreign Application Priority Data
Jan. 14, 2011 (KR) 10-2011-0003904

(51) Int. Cl. G06Q 40/00; H04W 64/00

(52) U.S. Cl. 705/39; 455/456.1; 455/456.3

(57) ABSTRACT

In an apparatus and a method for generating mobile consumption patterns, the apparatus includes: an information processing unit and storage unit that processes card use information from a server and stores the card use information including GPS information; an application unit to process the card use information and a sharing unit to share the stored card use information with another user via a network, or a display unit to display augmented reality based on the card use information and GPS information.

### CROSS-REFERENCE TO RELATED APPLICATION

This application claims priority from and the benefit under 35 U.S.C. §119(a) of Korean Patent Application No. 10-2011-0003904, filed on Jan. 14, 2011, which is incorporated by reference for all purposes as if fully set forth herein.

### BACKGROUND

1. Field

The present disclosure relates to an apparatus and a method for generating consumption patterns.

2. Discussion of the Background

As consumers use card payments with a greater frequency than that of cash transactions, the importance of analysis and management of card payment use has increased. In addition, as more mobile terminals are also used, a system to check card expenditure details using a mobile terminal has been developed.

FIG. 1 is a flowchart illustrating a method for showing a card transaction detail according to the related art.

Referring to FIG. 1, the method for card transaction detail management for a mobile communication terminal using a short message service (SMS) includes: receiving a short message about card transaction details via a mobile communication terminal (S1); extracting data regarding the card transaction details from the short message (S2); arranging the extracted data together with card transaction details stored in advance and displaying the total amount of money used (S3); and storing the result in a memory of the mobile communication terminal (S4). Thus, a card use may be managed.

Because the card transaction details received as the short message is automatically stored in a database (DB), the card use details can be checked without keeping household accounts. However, this information may already be provided by information from an internet source, such as a web page and the like. In addition, if a card company is added or the content format of a card details message is changed, there is a problem that an algorithm in a stage of extracting information needs to be modified. In addition, there is problem that if a card is used in the past, it may be difficult to remember a location where the card is used.

FIG. 2 is a flowchart showing a method for selecting and retrieving card use results according to the related art.

Referring to FIG. 2, the related art provides the text message selecting and retrieving method for card use results for use with a mobile terminal. Specifically, after a is supplementary service for notifying the card use with a Short Message Service (SMS) text message is requested (S12), and when a card payment is made (S22), a payment approval request including a card number and a user's phone number is sent to a card company server through VAN/PG (S32). After an SMS text message including the card use result in which a Callback URL is included is received (S42), the card payment is approved by inputting a password and the card approval result is transmitted to a payment gateway server (S52), and the received SMS text message including the card use result is stored in a storage box (S62). Then, information such as the use details or use details in different periods can be checked by a customer terminal (S72 and S82).

In this case, a service that connects a network provider to servers of card companies has to be provided for card payment approval request and user authentication. However, a problem occurs because a contract has to be made in advance in order for there to be a server connection. In addition, since information, such as card numbers and card passwords, has to be transmitted and received through messages, there is a high possibility that important personal information may be compromised.

### SUMMARY

Exemplary embodiments provide an apparatus and method for generating consumption patterns for a mobile terminal decreases the likelihood that important personal information is compromised. Specifically, the information used may include card transaction details, amount of money, and additional information including GPS information or the like, and may be shared by others using social networking services (SNS) or AR techniques.

Additional features of the invention will be set forth in the description which follows, and in part will be apparent from the description, or may be learned by practice of the invention.

An exemplary embodiment provides a mobile terminal, including: an information processing unit to communicate with a server and to receive card use information; storage unit to store the card use information along with GPS information; and an application unit to process the card use information and the GPS information.

An exemplary embodiment provides a mobile terminal, including: information processing unit to process a payment with card use information; storage unit to store the card use information along with GPS information; and an application process the card use information and the GPS information.

An exemplary embodiment provides for generating a consumption pattern, including receiving card use information; processing the card use information with GPS information; and storing the card use information and the GPS information.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method for showing a card transaction detail according to the related art.

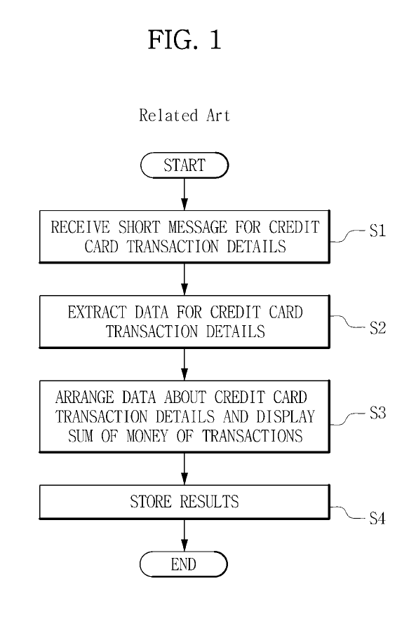

FIG. 2 is a flowchart illustrating a method for selecting and retrieving card use results according to the related art.

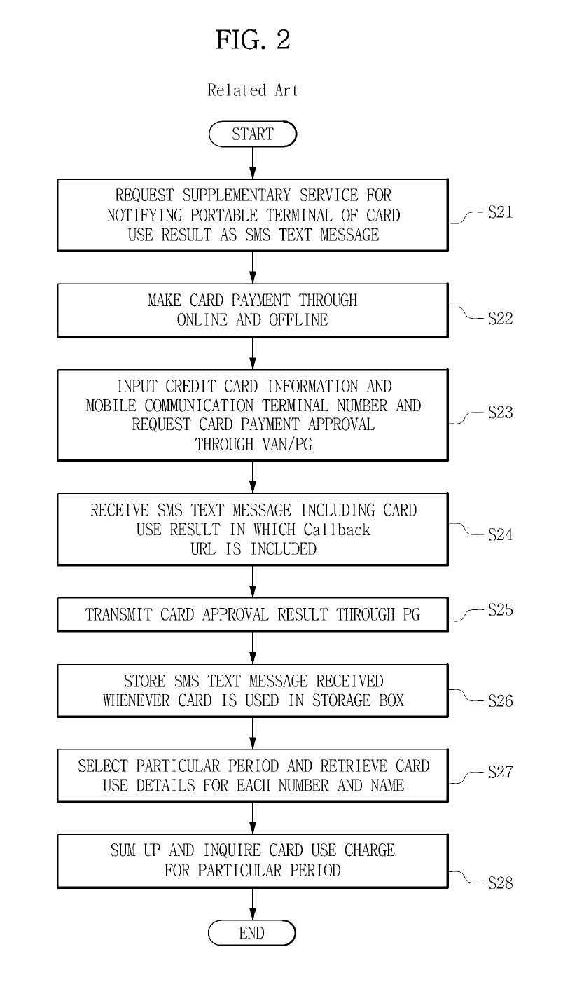

FIG. 3 is a view of a mobile terminal according to an exemplary embodiment.

FIG. 4 is a block diagram of the mobile terminal according to an exemplary embodiment.

FIG. 5 is a flowchart method for generating consumption pattern information according to an exemplary embodiment.

FIG. 6 is a block diagram of a mobile terminal according to an exemplary embodiment.

FIG. 7 is a flowchart illustrating a method for generating consumption pattern information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary is embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

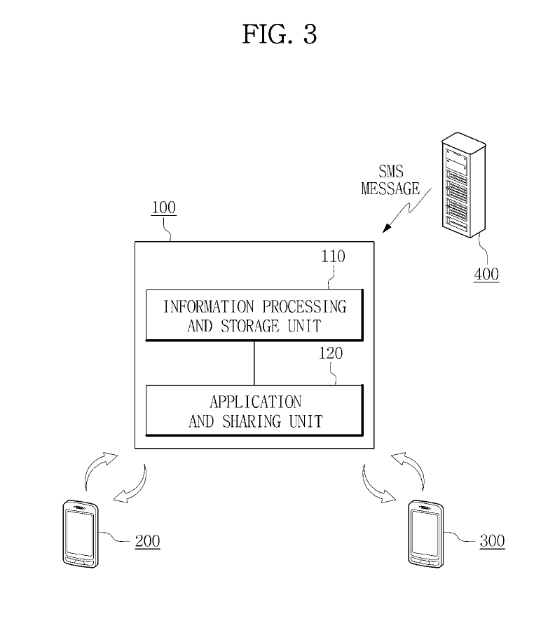

FIG. 3 is a view of a mobile terminal according to an exemplary embodiment.

Referring to FIG. 3, the mobile consumption pattern apparatus 100 (hereinafter, referred to as a mobile terminal) may include an information processing and storage unit 110. The information processing and storage unit 110 receives and processes card use information from an external server 400 as a message (such as SMS messages) and stores the card use information, which may include GPS information. The mobile terminal 100 may also include an application and sharing unit 120, which is connected to the information processing and storage unit 110, and allows the mobile terminal 100 to share the stored card use information with card use information of other devices, such as mobile terminals 200 and 300 via a network, or display the card use information on a display unit (not shown) as augmented reality on the basis of GPS information.

Specifically, the mobile terminal 100 may be realized with any terminal capable of receiving messages through wired and/or wireless communications, such as, portable phones, personal digital assistants (PDAs), tablets, laptops, desktops, and the like. In addition, the message may be a Short Message Service (SMS) message, a Multimedia Messaging Service (MMS) message, or the like.

If a user makes a payment with a credit card, a server of the credit card company transmits corresponding card use information. The information processing and storage unit 110 is receives a message from the external server 400, and thereafter determines whether GPS information regarding a location where the card is used is included in the received message. The card use information included in a message may include card type, position, amount of money, saved points, and the like. The GPS information refers to computer-readable information corresponding to the GPS position at the location where the card is used. The mobile terminal 100 displays the card use information as augmented reality based on the GPS information. Therefore, if the GPS information is not included in the received message, the GPS information is acquired. If the GPS information is acquired and stored, the application and sharing unit 120 displays, on the basis of the stored card use information and GPS information, the card use information as an augmented reality using distances and locations displayed on the display (not shown) of the mobile terminal 100. Although referred to as GPS information, aspects of the invention are not limited thereto such that the GPS information may be, generally, location information, and may include location information acquired from other sources, such as triangulation and/or the location of a nearby accessed server.

Augmented reality is a technique for overlapping virtual objects/information with an image of the real world. The augmented reality combines the virtual world having supplementary information, with the real world, to be shown as a single image in real time. Another term for augment reality may be mixed reality (MR). A virtual reality technique merely contains a virtual environment, and does not present a real environment.

However, with the augmented reality technique, since the real environment is viewed, a better sense of reality is experienced due to the supplementary information. For example, if a smart phone camera is aimed at its surroundings, information such as the positions and telephone numbers of nearby shop may be displayed. Therefore, according to an exemplary embodiment, it may be possible to display information regarding card use information along with an image of the surrounding location of the mobile terminal 100.

The card use information may be seen using the augmented reality, and/or information on acquaintances may be shared. The sharing may occur due to social networking services (SNS). An SNS is a service that allows users to build social networks on the web and other mediums. Some examples of SNS are Twitter, Cyworld, Facebook, etc. Therefore, SNS allows users to strengthen personal relations with friends, seniors and juniors, colleagues, acquaintances, etc. and form wide social networks (human relationships) by widening personal connections, using the web. The mobile terminal 100 may share the stored card use information with other mobile terminals 200 and 300. Here, other' mobile terminals 200 and 300 may include various types of communication devices that use SNS, such as personal computers, PDAs, and netbooks. Through such SNS, more efficient lives as consumers may be achieved by acquiring shared card use information and additional information regarding locations or spaces where cards are used.

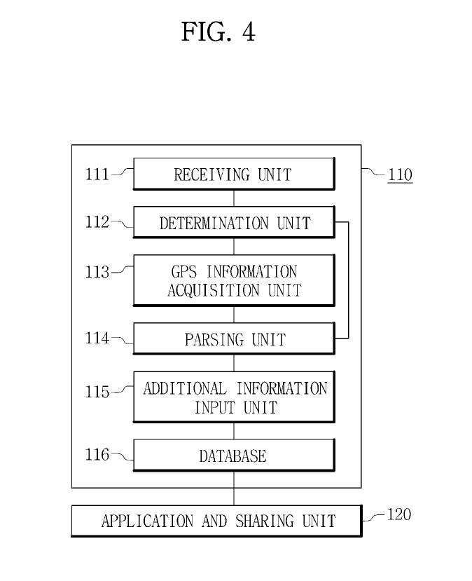

FIG. 4 is a block diagram of the mobile terminal according to an exemplary embodiment.

Referring to FIG. 4, the information processing and storage unit 110 may include a receiving unit 111, a determination unit 112 connected to the receiving unit 111, a GPS information acquisition unit 113 connected to the determination unit 112, a parsing unit 114 connected to the GPS information acquisition unit 113 and determination unit 112, an additional information input unit 115 connected to the parsing unit 114, and a database 116 connected to the additional information input unit 115. More specifically, the receiving unit 111 receives card use information as a message from the external server 400, which may be a server of the card company. The determination unit 112 determines whether the card use information received as the message includes GPS information. If the determination unit 112 determines that the card use information includes GPS information, the determination unit 112 transmits the card use information to the parsing unit 114. The determination unit 112 may immediately transmit the card use information to the parsing unit 114 if the card use includes GPS information. However, if the determination unit 112 determines that the card use information does not include GPS information, the determination unit 112 transmits the card use information to the GPS information acquisition unit 113, and the GPS information acquisition unit 113 acquires GPS information. As a result, the card use information includes GPS information. The parsing unit 114 parses the card use information including such GPS information, and the parsed card use information may include, in addition to the GPS information, card type, the position of a place where the card is used, amount of money, saved points, and the like. The parsed card use information may be stored in the database 116, or may be provided with further detailed card use information by the additional information input unit 115, and then stored in the database 116. For example, the user may input, as well as general card use information, such as additional discount information, other discount card types that can be accepted by the places where the card is used, user satisfaction, restaurant URL information, and the like, through the additional information input unit 115. The database 116 stores the parsed card use information or the card use information including the additional information, and connects to the application and sharing unit 120 to display the information with augmented reality, or share the information with others. GPS information acquisition unit 113 may be a location information acquisition unit and receive or determine the location information via another source or process, such as triangulation, object recognition, or input location.

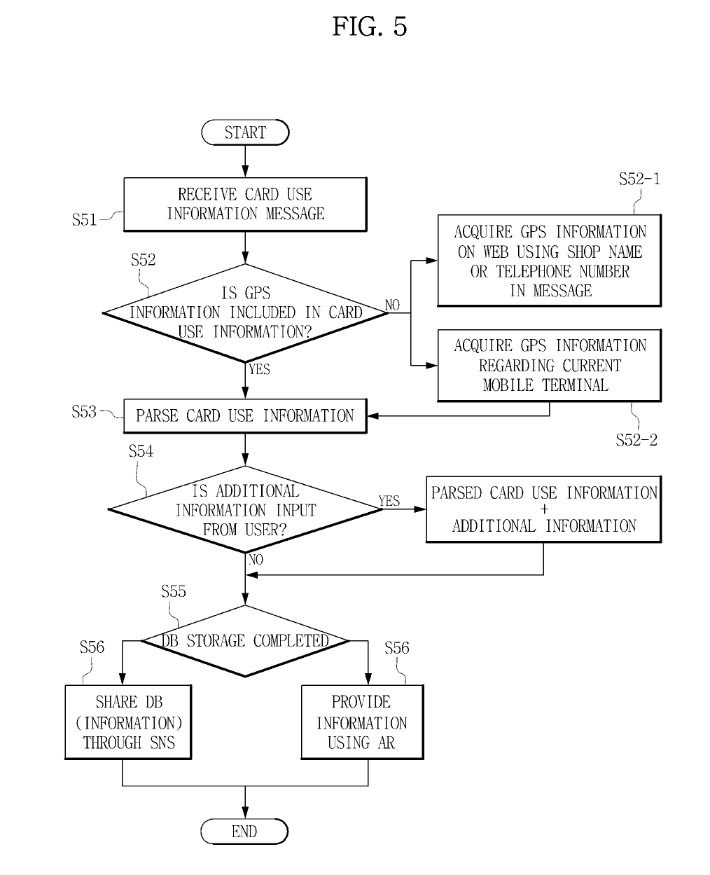

FIG. 5 is a flowchart illustrating a method for generating consumption pattern information according to an exemplary embodiment.

Referring to FIG. 5, a card use message is received (S51), and it is determined whether GPS information is included in the card use message (S52). If it is determined that GPS information is included, a message parsing process (S53) is performed. If not, a GPS information acquisition process (S52-1 or S52-2) is performed. In the GPS information acquisition process, GPS information is acquired on the web using a shop name or telephone number in that may be included in the card use message (S52-1), or GPS information is acquired based on GPS information regarding the current mobile terminal 100 location (S52-2). Here, the process of acquiring the current GPS information about the mobile terminal 100 (S52-2) is applicable if the user does not leave the place of payment. As a result, the card use information subjected to the GPS information acquisition process (S52-1 or S52-2) includes GPS information. Thereafter, the card use information is parsed, so that card type, the position of the place where the card is used, amount of money, saved points, and the like as well as the GPS information are extracted (S53). In addition, the user may input additional information, for example, other discount card types that can be accepted by the places where the card is used, user satisfaction, and associated restaurants URLs, and the like, to the parsed card use information (S54). Here, the process of inputting the additional information by the user is optionally performed. Therefore, the card use information subjected only to the parsing process may be stored in the database at operation S3. The card use information or the card use information with the additional information is stored in the database (S55). The stored information may be shared by other users through SNS or may be provided as an augmented reality through the display unit (not shown) of the mobile terminal 100. In addition, the is information provided as the augmented reality may incorporate, as well as the user's own card use information, other users' card use information, and the information may be shared through SNS. Therefore, more objective and a greater amount of information may be viewed with the augmented reality display.

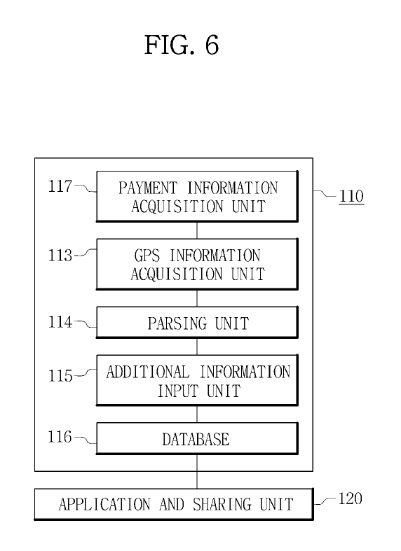

FIG. 6 is a block diagram of a mobile terminal according to an exemplary embodiment.

Referring to FIG. 6, the mobile consumption pattern providing and sharing apparatus (i.e., mobile terminal) 110 includes a payment information acquisition unit 117, a GPS information acquisition unit 113 connected to the payment information acquisition unit 117, a parsing unit 114 connected to the GPS information acquisition unit 113, an additional information input unit 115 connected to the parsing unit 114, and a database 116 connected to the additional information input unit 115. More specifically, the mobile terminal 110 may be used for payment instead of a card. Therefore, card use information is not received from the external server 400, and payment information regarding the payment made by the payment information acquisition unit 117. The payment may be made by using a chip embedded in the mobile terminal 110, or by other processes, such as display of a barcode or a quick response code. In addition, after the payment, the GPS information acquisition unit 113 acquires current GPS information regarding the mobile terminal 100. As a result, the payment information includes the GPS information and is transmitted to the parsing unit 114. The parsing unit 114 parses the payment information including the GPS information, and the parsed payment information includes, as well as the GPS information, payment space, payment price, saved points, and the like. The parsed payment information may be stored in the database 116, or may be provided with further detailed payment information by the additional information input unit 115 and then stored in the database. For example, the user may input additional information, such as additional account information, user satisfaction, and restaurant URL information, and the like, through the additional information input unit 115. The database 116 stores the parsed payment information or the payment information including the additional information, and is connected to the application and sharing unit 120 to display an augmented reality or share the information with other users or devices.

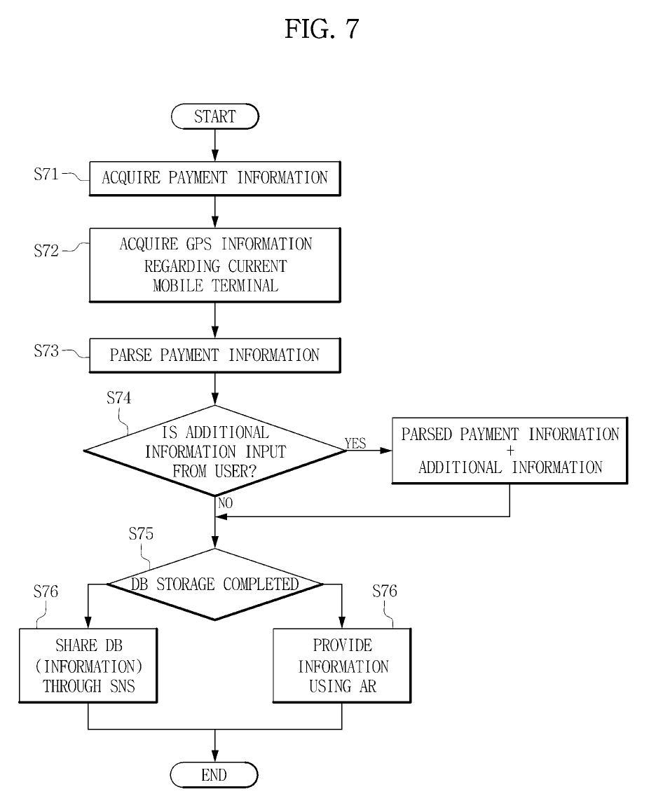

FIG. 7 is a flowchart illustrating a method for generating consumption pattern information according to an exemplary embodiment.

Referring to FIG. 7, payment information regarding a payment made by the mobile terminal 110 is acquired (S71). Current GPS information or location information regarding the mobile terminal 110 is acquired (S72). Since the user makes the payment with the mobile terminal 110, the GPS information may be acquired immediately after operation S1. Thus, the payment information may include GPS information or location information. Thereafter, card use information is parsed, and position of the payment space, payment price, saved points, and the like, as well as the GPS information or location information, are extracted (S73). In addition, the user may input additional information such as user satisfaction and/or restaurant URL information to the payment information (S74). Here, the process of inputting the additional information by the user is optional. Therefore, the payment information subjected only to the parsing process may be stored in the database 116 at operation S75. The payment information or the payment information including the additional information is stored in the database 116 (S75). The stored information may be shared to other users through SNS or may be provided as an augmented reality through the display unit (not shown) of the mobile terminal 110 (S76-1). In addition, the information provided as the augmented reality may be, as well as is the user's own card use information, incorporate others card use information shared through SNS (S76-2).

According to this disclosure, if a payment is made using a card or a mobile terminal, use details are provided to the mobile terminal to be incorporated as an augmented reality display, thereby allowing for more efficient consumption and shopping. In addition, reliable information can be selectively shared by users who are friends, so that information, such as user consumption patterns or preferred establishments based on use information for each card company per period or location can be shared more conveniently using mobile terminal devices and SNS.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
an information processing unit to communicate with a server and to receive card use information;
storage unit to store the card use information along with location information; and
an application unit to process the card use information and the location information.

2. The mobile terminal according to claim 1, further comprising:
a display unit to display the card use information and the location information with a real-world image, as augmented reality.

3. The mobile terminal according to claim 1, further comprising:
a sharing unit to share the card use information and the location information with another user or mobile device via a network.

4. The mobile terminal according to claim 1, further comprising:
a receiving unit to receive card use information from the server;
a determination unit to determine whether location information is included in the card use information;
a location information acquisition unit to acquire the location information if the location information is not included in the card use information;
a parsing unit to parse the card use information and the location information; and
a database to store the parsed card use information and the location information.

5. The mobile terminal according to claim 4, wherein the location information acquisition unit acquires the location information from an internet source or a location of the card use.

6. The mobile terminal according to claim 4, wherein the location information acquisition unit acquires the location information based on a current location of the mobile terminal.

7. The mobile terminal according to claim 1, wherein the card use information includes at least one of the following: card type, card use position, amount of money, and saved points.

8. The mobile terminal according to claim 4, further comprising:
an additional information input unit to receive additional information,
wherein the parsing unit adds the additional information to the card use information.

9. The mobile terminal according to claim 8, wherein the additional information includes at least one of the following: additional discount information, discount card types, user satisfaction, and restaurant URL information.

10. The mobile terminal according to claim 3, wherein the network is a social networking service (SNS).

11. The apparatus according to claim 2, wherein the augmented reality incorporates card use information from another user.

12. A mobile terminal, comprising:
an information processing unit to process payment information made by the mobile terminal;
a storage unit to store the payment information along with location information; and
an application unit to process the payment information and location information.

13. The mobile terminal according to claim 12, further comprising:
a display unit to display the payment information and the location information with a real-world image, as augmented reality.

14. The mobile terminal according to claim 12, further comprising:
a sharing unit to share the card use information and the location information with another user or mobile device via a network.

15. The mobile terminal according to claim 12, further comprising:
a payment information acquisition unit to acquire the payment information;
a location information acquisition unit to acquire location information regarding a position of the mobile terminal during the payment;
a parsing unit to parse the payment information and the location information; and
a database to store the parsed payment information and the location information.

16. The mobile terminal according to claim 15, wherein the location information acquisition unit acquires the location information based on a current location of the mobile terminal.

17. The mobile terminal according to claim 15, further comprising:
an additional information input unit to receive additional information,
wherein the parsing unit adds the additional to the payment information.

18. The mobile terminal according to claim 17, wherein the additional information includes at least one of the following: additional discount information, discount card types, user satisfaction, and restaurant URL information.

19. The mobile terminal according to claim 14, wherein the network is a social networking service (SNS).

20. The mobile terminal according to claim 13, wherein the augmented reality incorporates card use information from another user.

21. A method for generating a consumption pattern, comprising:
processing a payment with location information; and
storing a record of the payment and the location information.

22. The method according to claim 21 further comprising:
receiving card use information from a server;
determining whether location information is included in the card use information;
acquiring the location information if the location information is not included in the card use information;
parsing the card use information including the location information; and
storing the parsed card use information and the location information.

23. The method according to claim 21 further comprising:
making the payment with a mobile terminal;
receiving the payment information from the mobile terminal;
determining whether location information is included in the payment information;
acquiring the location information if the location information is not included in the payment information;
parsing the payment information including the location information; and
storing the parsed card use information and the location information.

24. The method according to claim 22, wherein the location information is acquired from an internet source or a location of the card use.

25. The method according to claim 23, wherein the location information is acquired from an internet source.

26. The method according to claim 22, wherein the location information is acquired based on a current location of a mobile terminal.

27. The method according to claim 23, wherein the location information is acquired based on a current location of the mobile terminal.

28. The method according to claim 22, wherein the card use information includes at least one of the following: card type, card use position, amount of money, and saved points.

29. The method according to claim 23, wherein the payment information includes at least one of the following: amount of money and saved points.

30. The method according to claim 22, further comprising:
inputting additional information,
wherein the additional information is added to the parsed card use information.

31. The method according to claim 23, further comprising:
inputting additional information,
wherein the additional information is added to the parsed payment information.

32. The method according to claim 30, wherein the additional information includes at least one of the following: additional discount information, discount card types, user satisfaction, and restaurant URL information.

33. The method according to claim 31, wherein the additional information includes at least one of the following: additional discount information, discount card types, user satisfaction, and restaurant URL information.

34. The method according to claim 21, further comprising:
displaying the record of the payment and the location information with a real-world image, as augmented reality.

35. The method according to claim 21, further comprising:
sharing of the record of the payment and the location information with another user or mobile device via a network.

36. The method according to claim 35, wherein the network is a social networking service (SNS).

37. The method according to claim 34, wherein the augmented reality incorporates card use information from another user.
